(19) United States
(12) Patent Application Publication
(10) Pub. No.: US 2022/0155435 A1
(43) Pub. Date: May 19, 2022

(54) ENVIRONMENT SENSING ASSISTED BY USER EQUIPMENT

(71) Applicants: ALIREZA BAYESTEH, OTTAWA (CA); NAVID TADAYON, KANATA (CA); JIANGLEI MA, OTTAWA (CA); WEN TONG, OTTAWA (CA)

(72) Inventors: ALIREZA BAYESTEH, OTTAWA (CA); NAVID TADAYON, KANATA (CA); JIANGLEI MA, OTTAWA (CA); WEN TONG, OTTAWA (CA)

(73) Assignee: HUAWEI TECHNOLOGIES CO., LTD., Shenzhen (CN)

(21) Appl. No.: 16/952,309

(22) Filed: Nov. 19, 2020

(51) Int. Cl. G01S 13/88

(52) U.S. Cl. CPC G01S 13/88; H04W 88/02

(57) ABSTRACT

Some aspects of the present disclosure provide a transmission point (e.g., a base station) with an ability to enlist a user equipment to help sense an environment. The transmission point may configure the user equipment to use specific sensing hardware and specific sensing signal parameters, including bandwidth and duration. Furthermore, the transmission point may configure the user equipment to use specific resources to report sensing results to the transmission point.

### TECHNICAL FIELD

The present disclosure relates generally to environment sensing and, in particular embodiments, to environment sensing assisted by user equipment.

### BACKGROUND

In a sensing-enabled communication network, a transmission point (TP) sends sensing signals to obtain information about an environment in which operates a user equipment (UE) that communicates with the TP.

The sensing signals may, in one example, be RADAR (Radio Azimuth Direction and Ranging) signals. The term RADAR need not always be expressed in all caps; “RADAR,” “Radar” and “radar” are equally valid. Radar is typically used for detecting a presence and a location of an object. A system using one type of radar, called “pulsed radar,” radiates a pulse of energy and receives echoes of the pulse from one or more targets. The system determines the pose of a given target based on the echoes returned from the given target. A system using another type of radar, called “pulse-compression radar,” uses the same amount of energy as is used in the pulsed radar system. However, in the pulse-compression radar system, the energy is spread in time and in frequency to reduce the instantaneous radiated power.

Environment sensing using radar signals has a very long history, particularly in military applications. Recently, the application of sensing using radar signals has been extended to vehicular applications for adaptive cruise control, collision avoidance and lane change assistance.

Another type of sensing signal is used in LIDAR (Light Detection and Ranging). Recently, advances in self-driving cars have relied on LIDAR technology to allow cars to sense the environment in which the cars are expected to navigate safely.

Elements of a given network may benefit from exploiting information regarding the position, the behavior, the mobility pattern, etc., of the UE in the context of a priori information describing a wireless environment in which the UE is operating. However, building a radio frequency map of the wireless environment using radar may be shown to be a highly challenging and open problem. The difficulty of the problem may be considered to be due to factors such as the limited resolution of sensing elements, the dynamicity of the environment and the huge number of objects whose electromagnetic properties and position are to be estimated.

### SUMMARY

Through signaling, a transmission point (e.g., a base station) may enlist a user equipment to help sense an environment. The transmission point may configure the user equipment to use specific sensing hardware and specific sensing signal parameters, including bandwidth and duration. Furthermore, the transmission point may configure the user equipment to use specific resources to report sensing results to the transmission point.

Aspects of the present application related to a user equipment assisting a transmission point by carrying out some environment sensing may be shown to improve sensing coverage and sensing diversity, when compared to environment sensing that is carried out by the transmission point alone. Indeed, the sensing coverage may be increased when the user equipment carries out sensing in an area of the environment that is, otherwise, a blind spot from the perspective of the transmission point. Mobile user equipment may be able to obtain multiple views of a single target from different angles. Environment sensing that is assisted by user equipment may provide an opportunity for close-range sensing of specific targets. It should be clear that close-range sensing can be performed with reduced power relative to long-range sensing. Furthermore, close-range sensing may be less encumbered by interference from various forms of clutter in the environment than long-range sensing.

According to a first aspect of the present disclosure, there is provided a method of assisting sensing of an environment. The method includes a sensing assisting device, such as a UE, receiving a configuration message and transmitting sensing results obtained by carrying out an environment sensing operation according to the details indicated in the configuration message. The configuration message indicates details of the environment sensing operation. The method further includes the device receiving reflections of radio frequency signals as part of carrying out the environment sensing operation.

According to an embodiment of the first aspect, the details of the environment sensing operation include at least one of: a sensing type; a sensing subspace; a target detection performance indicator; a sensing waveform; a sensing signal sequence; a sensing signal time/frequency allocation; an active sensing request; a passive sensing request; a common sensing indication; a dedicated sensing indication; a feedback channel resource; or a sensing report timeline.

According to another embodiment of the first aspect or further to the first embodiment, carrying out the environment sensing operation comprises an active sensing operation. The active sensing operation includes the device transmitting a first radio frequency signal. In the active sensing operation, receiving the reflections of radio frequency signals comprises receiving reflections of the first radio frequency signal.

According to another embodiment of the first aspect or further to any previous embodiment, carrying out the environment sensing operation comprises a passive sensing operation. In the passive sensing operation receiving the reflections of radio frequency signals includes receiving reflections of radio frequency signals existing in the environment.

According to another embodiment of the first aspect or further to any previous embodiment, the method further includes the device transmitting an indication of sensing capabilities.

According to another embodiment of the first aspect or further to any previous embodiment, the method further includes the device transmitting an indication of sensing availability.

According to a second aspect of the present disclosure, there is provided a method of controlling sensing of an environment. The method includes a sensing requesting device, such as a base station or another UE, transmitting a configuration message and receiving sensing results obtained by processing received reflections. The reflections are received by a device carrying out an environment sensing operation according to details indicated in the configuration message.

According to an embodiment of the second aspect, the method further includes the device receiving an indication of sensing capabilities.

According to another embodiment of the second aspect or further to the first embodiment, the method further includes the device receiving an indication of sensing availability.

According to another embodiment of the second aspect or further to any previous embodiment, the configuration message further indicates resources to use when transmitting the sensing results and the method further comprises employing the resources when receiving the sensing results.

According to another embodiment of the second aspect or further to any previous embodiment, the configuration message further indicates a sensing type. In a further embodiment, the sensing type comprises one of a radio frequency sensing type, a LIDAR sensing type, or a camera-based sensing type.

According to another embodiment of the second aspect or further to any previous embodiment, the configuration message further indicates at least one of a sensing timing allocation, a sensing period, or a sensing report timeline.

According to another embodiment of the second aspect or further to any previous embodiment, the method further includes the device transmitting a request message indicating a request for sensing assistance and receiving a response message responding to the request for sensing assistance.

According to another embodiment of the second aspect or further to any previous embodiment, the method further includes the device transmitting a message indicating an instruction to carry out the sensing operation. The message indicates the instruction further comprises an indication of at least one of a sensing type, a sensing signal bandwidth, a sensing signal duration, a sensing timing allocation, a sensing period, or a sensing report timeline.

According to another aspect of the present disclosure, there is provided a device. The device includes a memory storing instructions and a processor. The processor is configured, by executing the instructions, to perform a method in accordance with any previous aspect or embodiment thereof.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1 is a schematic diagram of a communication system in which embodiments of the disclosure may occur, the communication system includes an example user equipment and an example base station;

FIG. 2 illustrates, in a block diagram, the example user equipment of the communication system of FIG. 1, in accordance with aspects of the present disclosure;

FIG. 3 illustrates, in a block diagram, the example base station of the communication system of FIG. 1, in accordance with aspects of the present application;

FIG. 4 illustrates a situation in which the user equipment may assist the base station in sensing the environment, in accordance with aspects of the present application;

FIG. 5 illustrates, in a signal flow diagram, interaction between user equipment and base station for arranging sensing assisted by the user equipment, in accordance with aspects of the present application;

FIG. 6 illustrates, in a signal flow diagram, further interaction between user equipment and base station for arranging sensing assisted by the user equipment, in accordance with aspects of the present application;

FIG. 7 illustrates a situation in which multiple user equipment may assist the base station in sensing the environment, in accordance with aspects of the present application; and

FIG. 8 illustrates Radio Resource Control states of a user equipment and indicates procedures used to transition between the states.

### DETAILED DESCRIPTION OF ILLUSTRATIVE EMBODIMENTS

For illustrative purposes, specific example embodiments will now be explained in greater detail in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include, or otherwise have access to, a non-transitory computer/processor readable storage medium or media for storage of information, such as computer/processor readable instructions, data structures, program modules and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e., DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

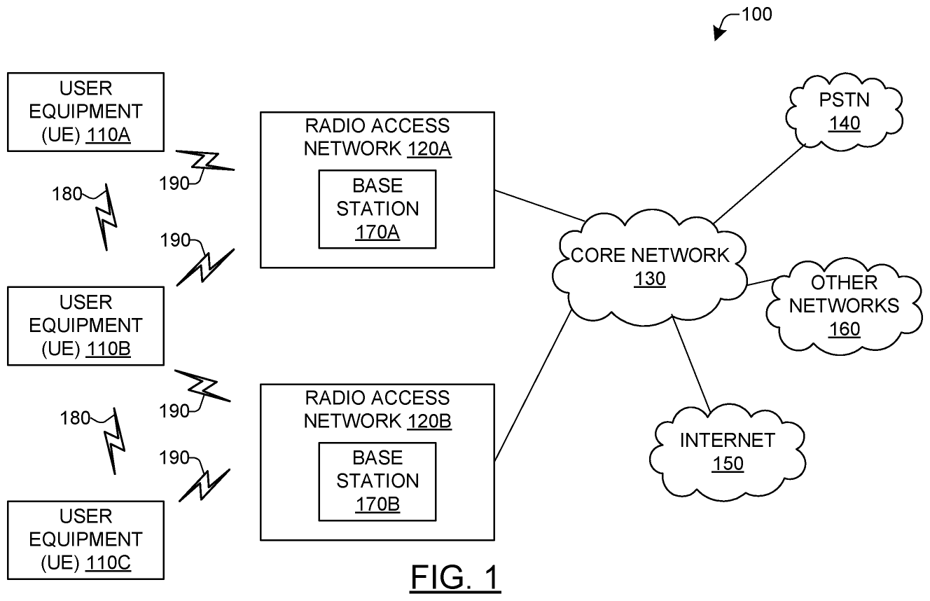

FIG. 1 illustrates, in a schematic diagram, an example communication system 100. In general, the communication system 100 enables multiple wireless or wired elements to communicate data and other content. The purpose of the communication system 100 may be to provide content (voice, data, video, text) via broadcast, narrowcast, user device to user device, etc. The communication system 100 may operate efficiently by sharing resources, such as bandwidth.

In this example, the communication system 100 includes a first user equipment (UE) 110A, a second UE 1106 and a third UE 110C (individually or collectively 110), a first radio access network (RAN) 120A and a second RAN 120B (individually or collectively 120), a core network 130, a public switched telephone network (PSTN) 140, the Internet 150 and other networks 160. Although certain numbers of these components or elements are shown in FIG. 1, any reasonable number of these components or elements may be included in the communication system 100.

The UEs 110 are configured to operate, communicate, or both, in the communication system 100. For example, the UEs 110 are configured to transmit, receive, or both via wireless communication channels. Each UE 110 represents any suitable end user device for wireless operation and may include such devices (or may be referred to) as a wireless transmit/receive unit (WTRU), a mobile station, a mobile subscriber unit, a cellular telephone, a station (STA), a machine-type communication device (MTC), an Internet of Things (IoT) device, a personal digital assistant (PDA), a smartphone, a laptop, a computer, a touchpad, a wireless sensor or a consumer electronics device.

In FIG. 1, the first RAN 120A includes a first base station 170A and the second RAN includes a second base station 170B (individually or collectively 170). The base station 170 may also be called an anchor or a transmit point (TP). Each base station 170 is configured to wirelessly interface with one or more of the UEs 110 to enable access to any other base station 170, the core network 130, the PSTN 140, the internet 150 and/or the other networks 160. For example, the base stations 170 may include (or be) one or more of several well-known devices, such as a base transceiver station (BTS), a Node-B (NodeB), an evolved NodeB (eNodeB), a Home eNodeB, a gNodeB, a transmission and receive point (TRP), a site controller, an access point (AP) or a wireless router. Any UE 110 may alternatively or additionally be configured to interface, access or communicate with any other base station 170, the internet 150, the core network 130, the PSTN 140, the other networks 160 or any combination of the preceding. The communication system 100 may include RANs, such as the RAN 120B, wherein the corresponding base station 170B accesses the core network 130 via the internet 150, as shown.

The UEs 110 and the base stations 170 are examples of communication equipment that can be configured to implement some or all of the functionality and/or embodiments described herein. In the embodiment shown in FIG. 1, the first base station 170A forms part of the first RAN 120A, which may include other base stations (not shown), base station controller(s) (BSC, not shown), radio network controller(s) (RNC, not shown), relay nodes (not shown), elements (not shown) and/or devices (not shown). Any base station 170 may be a single element, as shown, or multiple elements, distributed in the corresponding RAN 120, or otherwise. Also, the second base station 170B forms part of the second RAN 120B, which may include other base stations, elements and/or devices. Each base station 170 transmits and/or receives wireless signals within a particular geographic region or area, sometimes referred to as a “cell” or “coverage area.” A cell may be further divided into cell sectors and a base station 170 may, for example, employ multiple transceivers to provide service to multiple sectors. In some embodiments, there may be established pico or femto cells where the radio access technology supports such. In some embodiments, multiple transceivers could be used for each cell, for example using multiple-input multiple-output (MIMO) technology. The number of RANs 120 shown is exemplary only. Any number of RANs may be contemplated when devising the communication system 100.

The base stations 170 communicate with one or more of the UEs 110 over one or more air interfaces 190 using wireless communication links, e.g., radio frequency (RF) wireless communication links, microwave wireless communication links, infrared (IR) wireless communication links, visible light (VL) communications links, etc. The air interfaces 190 may utilize any suitable radio access technology. For example, the communication system 100 may implement one or more orthogonal or non-orthogonal channel access methods, such as code division multiple access (CDMA), time division multiple access (TDMA), frequency division multiple access (FDMA), space division multiple access (SDMA), orthogonal FDMA (OFDMA) or single-carrier FDMA (SC-FDMA) in the air interfaces 190.

A base station 170 may implement Universal Mobile Telecommunication System (UMTS) Terrestrial Radio Access (UTRA) to establish the air interface 180 using wideband CDMA (WCDMA). In doing so, the base station 170 may implement protocols such as High Speed Packet Access (HSPA), Evolved HPSA (HSPA+) optionally including High Speed Downlink Packet Access (HSDPA), High Speed Packet Uplink Access (HSUPA) or both. Alternatively, a base station 170 may establish the air interface 180 with Evolved UTMS Terrestrial Radio Access (E-UTRA) using LTE, LTE-A, LTE-B and/or 5G New Radio (NR). It is contemplated that the communication system 100 may use multiple channel access functionality, including such schemes as described above. Other radio technologies for implementing air interfaces include IEEE 802.11, 802.15, 802.16, CDMA2000, CDMA2000 1×, CDMA2000 EV-DO, IS-2000, IS-95, IS-856, GSM, EDGE and GERAN. Of course, other multiple access schemes and wireless protocols may be utilized.

The RANs 120 are in communication with the core network 130 to provide the UEs 110 with various services such as voice communication services, data communication services and other communication services. The RANs 120 and/or the core network 130 may be in direct or indirect communication with one or more other RANs (not shown), which may or may not be directly served by the core network 130 and may or may not employ the same radio access technology as the first RAN 120A, the second RAN 120B or both. The core network 130 may also serve as a gateway access between (i) the RANs 120 or the UEs 110 or both, and (ii) other networks (such as the PSTN 140, the Internet 150 and the other networks 160).

The UEs 110 may communicate with one another over one or more sidelink (SL) air interfaces 180 using wireless communication links, e.g., radio frequency (RF) wireless communication links, microwave wireless communication links, infrared (IR) wireless communication links, visible light (VL) communications links, etc. The SL air interfaces 180 may utilize any suitable radio access technology and may be substantially similar to the air interfaces 180 over which the UEs 110 communicate with one or more of the base stations 170 or they may be substantially different. For example, the communication system 100 may implement one or more channel access methods, such as CDMA, TDMA, FDMA, SDMA, OFDMA or SC-FDMA in the SL air interfaces 180. In some embodiments, the SL air interfaces 180 may be, at least in part, implemented over unlicensed spectrum.

Some or all of the UEs 110 may include functionality for communicating with different wireless networks over different wireless links using different wireless technologies and/or protocols. Instead of wireless communication (or in addition thereto), the UEs 110 may communicate via wired communication channels to a service provider or a switch (not shown) and to the Internet 150. The PSTN 140 may include circuit switched telephone networks for providing plain old telephone service (POTS). The Internet 150 may include a network of computers and subnets (intranets) or both and incorporate protocols, such as internet protocol (IP), transmission control protocol (TCP) and user datagram protocol (UDP). The UEs 110 may be multimode devices capable of operation according to multiple radio access technologies and incorporate multiple transceivers necessary to support multiple radio access technologies.

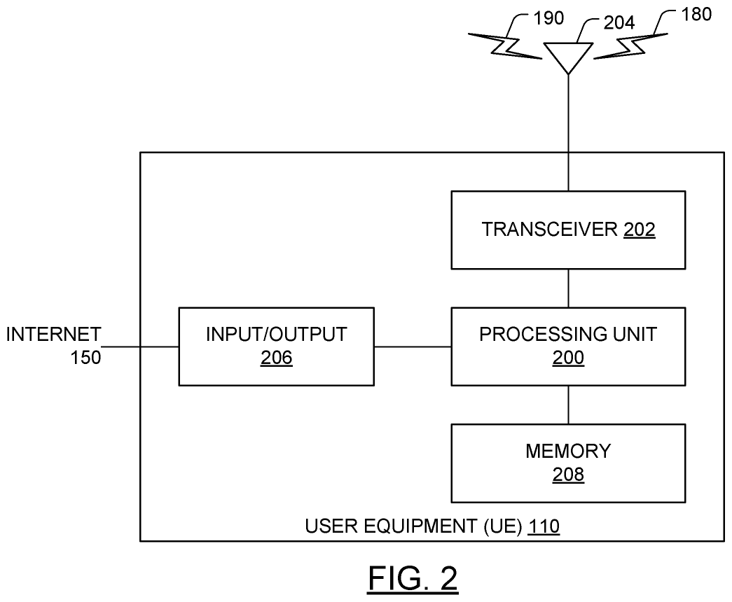

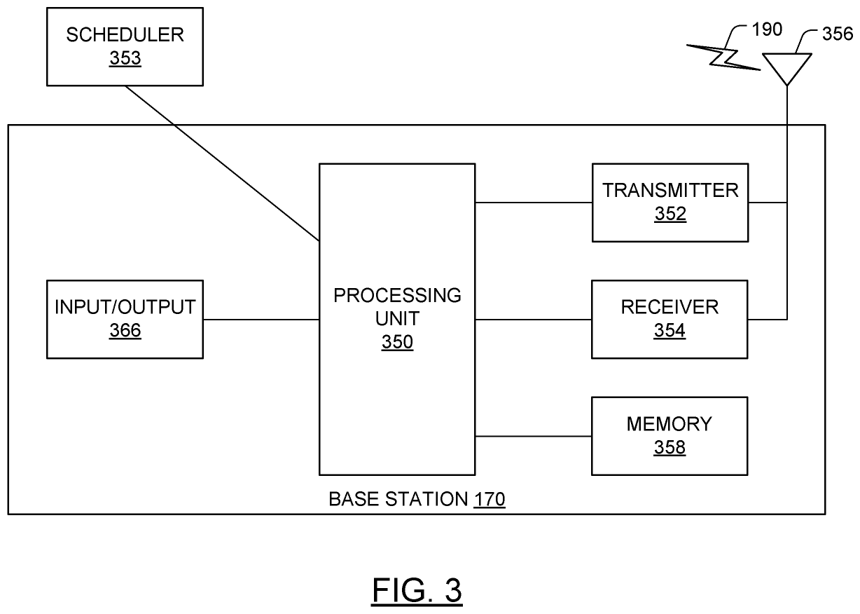

FIGS. 2 and 3 illustrate example devices that may implement the methods and teachings according to this disclosure. In particular, FIG. 2 illustrates an example UE 110 and FIG. 3 illustrates an example base station (BS) 170. These components could be used in the communication system 100 of FIG. 1 or in any other suitable system.

As shown in FIG. 2, the UE 110 includes at least one UE processing unit 200. The UE processing unit 200 implements various processing operations of the UE 110. For example, the UE processing unit 200 could perform signal coding, data processing, power control, input/output processing, or any other functionality enabling the UE 110 to operate in the communication system 100. The UE processing unit 200 may also be configured to implement some or all of the functionality and/or embodiments described in more detail above. Each UE processing unit 200 includes any suitable processing or computing device configured to perform one or more operations. Each UE processing unit 200 could, for example, include a microprocessor, microcontroller, digital signal processor, field programmable gate array, or application specific integrated circuit.

The UE 110 also includes at least one transceiver 202. The transceiver 202 is configured to modulate data or other content for transmission by at least one antenna or Network Interface Controller (NIC) 204. The transceiver 202 is also configured to demodulate data or other content received by the at least one antenna 204. Each transceiver 202 includes any suitable structure for generating signals for wireless or wired transmission and/or processing signals received wirelessly or by wire. Each antenna 204 includes any suitable structure for transmitting and/or receiving wireless or wired signals. One or multiple transceivers 202 could be used in the UE 110. One or multiple antennas 204 could be used in the ED 110. Although shown as a single functional unit, a transceiver 202 could also be implemented using at least one transmitter and at least one separate receiver.

The UE 110 further includes one or more input/output devices 206 or interfaces (such as a wired interface to the Internet 150). The input/output devices 206 permit interaction with a user or other devices in the network. Each input/output device 206 includes any suitable structure for providing information to or receiving information from a user, such as a speaker, microphone, keypad, keyboard, display, or touch screen, including network interface communications.

In addition, the UE 110 includes at least one UE memory 208. The UE memory 208 stores instructions and data used, generated, or collected by the ED 110. For example, the UE memory 208 could store software instructions or modules configured to implement some or all of the functionality and/or embodiments described above and that are executed by the UE processing unit(s) 200. Each UE memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, and the like.

As shown in FIG. 3, the base station 170 includes at least one BS processing unit 350, at least one transmitter 352, at least one receiver 354, one or more antennas 356, at least one BS memory 358, and one or more input/output devices or interfaces 366. A transceiver, not shown, may be used instead of the transmitter 352 and receiver 354. A scheduler 353 may be coupled to the BS processing unit 350. The scheduler 353 may be included within or operated separately from the base station 170. The BS processing unit 350 implements various processing operations of the base station 170, such as signal coding, data processing, power control, input/output processing, or any other functionality. The BS processing unit 350 can also be configured to implement some or all of the functionality and/or embodiments described in more detail above. Each BS processing unit 350 includes any suitable processing or computing device configured to perform one or more operations. Each BS processing unit 350 could, for example, include a microprocessor, microcontroller, digital signal processor, field programmable gate array, or application specific integrated circuit.

Each transmitter 352 includes any suitable structure for generating signals for wireless or wired transmission to one or more UEs or other devices. Each receiver 354 includes any suitable structure for processing signals received wirelessly or by wire from one or more UEs or other devices. Although shown as separate components, at least one transmitter 352 and at least one receiver 354 could be combined into a transceiver. Each antenna 356 includes any suitable structure for transmitting and/or receiving wireless or wired signals. Although a common antenna 356 is shown here as being coupled to both the transmitter 352 and the receiver 354, one or more antennas 356 could be coupled to the transmitter(s) 352, and one or more separate antennas 356 could be coupled to the receiver(s) 354. Each BS memory 358 includes any suitable volatile and/or non-volatile storage and retrieval device(s) such as those described above in connection to the UE 110. The BS memory 358 stores instructions and data used, generated, or collected by the base station 170. For example, the BS memory 358 could store software instructions or modules configured to implement some or all of the functionality and/or embodiments described above and that are executed by the BS processing unit(s) 350.

Each input/output device 366 permits interaction with a user or other devices in the network. Each input/output device 366 includes any suitable structure for providing information to or receiving/providing information from a user, including network interface communications.

Consider a network wherein all UEs 110 and all BSs 170 are capable of both a communication functionality and a sensing functionality. In such a network, which might be called an “integrated communications and sensing network,” all UEs 110 and all BSs 170 can be involved in the sensing process, thereby leading to improvements in environment recognition.

It is expected that UEs 110 in the future will have a variety of sensing capabilities, including RF sensing capabilities, photographic sensing capabilities and LIDAR sensing capabilities. These sensing capabilities can be used for environment characterization and recognition. Due to potential movement of UEs 110 in the network, a single UE 110 can, over time, provide views of a given environment from a variety of different angles.

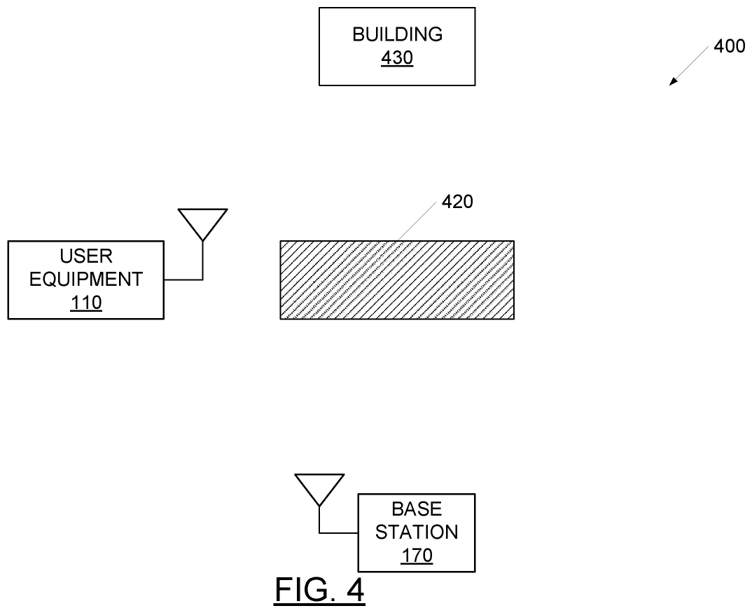

There are scenarios for which sensing based at the BS 170 may not be efficient and feasible. As shown in FIG. 4, an environment 400 includes a BS 170, a UE 110, a wall 420 and a building 430. The BA 170 may try to obtain knowledge of the environment 400 using RF radar sensing signals. However, the ability of the BS 170 to obtain knowledge of the building 430 is hampered by the presence of the wall 420.

Environment sensing that is purely based at the BS 170, as is common, is inefficient, in terms of power consumption and performance, for environment characterization (e.g., due to blind spots). Aspects of the present application are directed to involving the UE 110 in the sensing process, in consideration of limitations of the UE 110, including UE-BS synchronization limitations and UE capability.

In overview, according to aspects of the present application, the BS 170 transmits, to the UE 110, a request for sensing assistance, that is, a request for assistance in performing environment sensing. The UE 110 may use sensing signals normally used by the BS 170 to sense the environment, thereby obtaining sensing results. The UE 110 may then transmit the sensing results to the BS 170. Alternatively, the UE 110 may use sensing signals that are different from the sensing signals used by the BS 170, due to the capability of the UE 110 being distinct from the capability of the BS 170.

For assisted sensing according to aspects of the present application, there may be considered to be two basic elements. A first basic element is a sensing requester, that is, an entity that requests that sensing be performed. A second basic element is a sensing performer, that is, an entity that performs the sensing operation. The sensing requester can be a UE 110 or any other network node, such as a BS 170. The sensing performer, for the purposes of the present application, is assumed to be a UE 110.

In terms of RF sensing, there are two scenarios. A first scenario may be referenced as “Active Sensing” and may involve transmitting RF sensing signals for the purpose of obtaining information from the environment. A second scenario may be referenced as “Passive Sensing.” In Passive Sensing, it is recognized that, even without sensing-specific RF signals, many RF signals are transmitted in the environment and that the interaction of these RF signals with elements of the environment can provide information about the elements with which the RF signals interact. Accordingly, Passive Sensing may involve receiving and processing those RF signals that have interacted with the environment. In any given environment, there can be multiple entities engaged in Active Sensing and/or multiple entities engaged in Passive Sensing. In some embodiments, one or more entities can perform both active sensing and passive sensing.

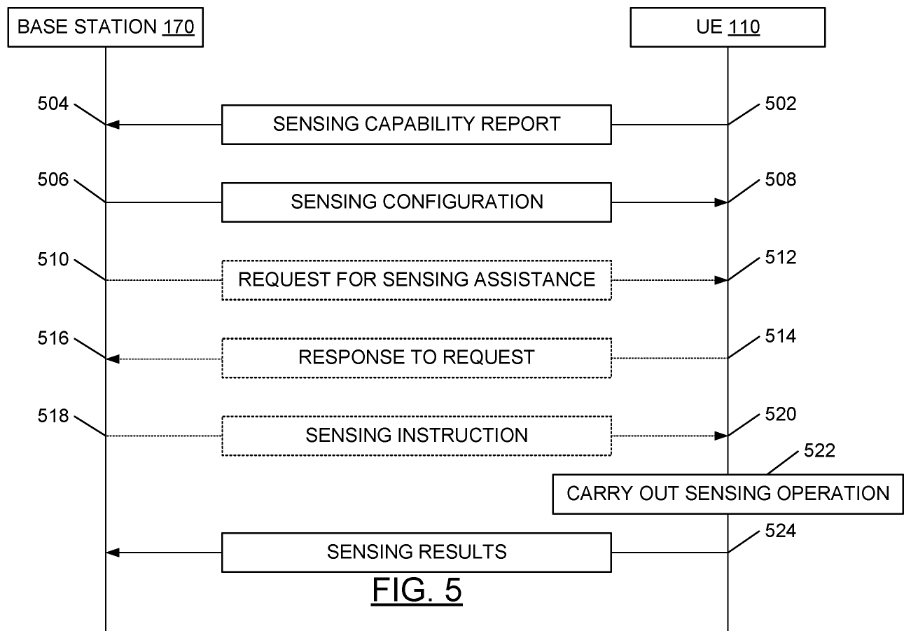

FIG. 5 illustrates, in a signal flow diagram, interaction between a UE 110 and a BS 170 for arranging sensing assisted by the UE 110.

Initially, the UE 110 transmits (step 502), to the BS 170, a sensing capability report indicating the sensing capability of the UE 110. The sensing capability report may include an indication of supported sensing types (including RF, imaging, LIDAR and camera) and the details of capability for each of supported sensing types. For example, for RF sensing, the sensing capability report may indicate a supported frequency bands and bandwidth, supported sensing signals and supported duplexing mode (full duplex or half duplex). The sensing capability report can be transmitted together with a known UE capability report. The known UE capability report is usually transmitted, to the BS 170 and by the UE 110, upon connecting to the BS 170.

Subsequent to receiving (step 504) the sensing capability report, the BS 170 may transmit (step 506), to the UE 110, a sensing configuration. Upon receiving (step 508) the sensing configuration, the UE 110 may implement the sensing configuration.

The BS 170 may, optionally, transmit (step 510), to the UE 110, a request for sensing assistance. The request may be defined as a new message between the BS 170 and the UE 110, with the new message including a “request to_sense” indication.

The BS 170 may, for one unicast example, employ the known physical downlink shared channel (PDSCH) to transmit (step 510) the request to_sense indication to the UE 110. The BS 170 may, for another unicast example, employ the known physical downlink control channel (PDCCH) to transmit (step 510) the request to_sense indication to the UE 110. In a group-cast example, the BS 170 may transmit (step 510) the request to sense indication to a group of UEs 110. When transmitting (step 510) to a group of UEs 110, the BS 170 may employ the known PDSCH or the known PDCCH. In other examples, the BS 170 may broadcast the transmission (step 510) of the request to_sense indication to all UEs 110. When broadcast transmitting (step 510) to all UEs 110, the BS 170 may employ the known physical broadcast channel (PBCH). Rather than employ a known physical channel, it is contemplated, herein, that a new physical channel may be defined expressly for the purpose of transmitting the request to_sense indication. The new physical channel may be called, for example, a physical sensing channel (PSCH).

The BS 170 may also use a logical channel, such as the known dedicated control channel (DCCH) to transmit (step 510) the request to_sense indication to the UE 110. Rather than employ a known logical channel, it is contemplated, herein, that a new logical channel may be defined expressly for the purpose of transmitting the request to_sense indication. The new logical channel may be called, for example, a dedicated sensing channel (DSCH).

The BS 170 may transmit (step 506, FIG. 5) the sensing configuration indication and may transmit (step 510) the request to_sense indication by UE-specific signaling using, for example, the known radio resource control (RRC) protocol. Given that the environment sensing carried out by the UE 110 is on-demand based, it may be shown that use of RRC signaling results reduced power consumption relative to some other signaling choices.

In the case of scheduled sensing, a request to_sense indication can be sent using broadcast signaling, using unicast signaling or using group-cast signaling. More particularly, a request to_sense indication can be sent using layer one (L1) signaling using a standardized information structure, such as the known downlink control information (DCI) information structure. Alternatively, a request to_sense indication can be sent using signaling at a layer higher than L1, such as using a control element (CE) in the known media access control (MAC) sublayer, that is, a “MAC-CE.”

The request to_sense indication may include an indication of a sensing type, where the sensing type may be an RF sensing type, a LIDAR sensing type or a camera-based sensing type. The RF sensing type may include a further indication of RADAR sensing type or imaging sensing type. The request to_sense indication may include a sensing subspace indication, limiting the sensing to be carried out by the UE 110 to particular directions for the sake of UE power saving. The request to sense indication may include an indication of key performance indicators (KPIs) for target detection. The KP Is may be related to range estimation, Doppler (velocity) estimation, sensing resolution and sensing accuracy. The request to sense indication may include an indication of detailed sensing signal configuration, which, in the case of RF sensing, may include a sensing waveform indication and its associated parameters, a sensing signal sequence indication, or an indication of sensing signal time/frequency allocation. The request to sense indication may include an indication of an active sensing request, in which the UE is requested to transmit an RF signal, a passive sensing request, in which the UE is requested to receive and process the reflection of an RF sensing signal, or both. The request to_sense indication may include an indication of sensing categories including a common sensing indication or a dedicated sensing indication. The request to sense indication may also include an indication of a channel resource for sensing feedback, or an indication of a sensing report timeline.

After receiving (step 508) the sensing configuration information and/or after receiving (step 512) the request to_sense indication, the UE 110 may, optionally, transmit (step 514) a further new message to the BS 170. The further new message may include a “respond to_sense” indication. The BS 170 may receive (step 516) the further new message. In the respond to_sense indication, the UE 110 may provide, to the BS 170, an indication of availability for a sensing operation. The UE 110 may base the indication of availability on the extent to which the UE 110 has scheduled an uplink (UL) transmission, a downlink (DL) reception, a sidelink (SL) transmission or a SL reception. Additionally, the UE 110 may base the indication of availability on power level or mobility. Additional capabilities can be reported along with the respond to_sense indication. Example additional capabilities may include an indication of mobility, an indication of direction of movement and an indication of power level.

The UE 110 may, for one example, employ the known physical multicast channel (PMCH) to transmit (step 514) the respond to_sense indication to the BS 170. The UE 110 may, for another example, employ the known physical uplink control channel (PUCCH) to transmit (step 514) the respond to_sense indication to the BS 170. In a further example, the UE 110 may employ the known physical uplink shared channel (PUSCH) to transmit (step 514) the respond to_sense indication to the BS 170. In a still further example, the UE 110 may employ the known physical random access channel (PRACH) to transmit (step 514) the respond to_sense indication to the BS 170. It has been discussed hereinbefore that a new physical channel (PSCH) may be defined expressly for the purpose of the BS 170 transmitting the request to_sense indication to the UE 110. It is noted that the new physical channel (PSCH) may also be defined to include the purpose of the UE 110 transmitting the respond to_sense indication to the BS 170. The UE 110 may also use a logical channel, such as the known DCCH to transmit (step 514) the respond to_sense indication to the BS 170. Alternatively, the UE 110 may use the newly defined logical channel (DSCH), discussed hereinbefore, to transmit (step 514) the respond to_sense indication to the BS 170.

Optionally, the BS 170 may transmit (step 518) an even further new message to the UE 110. The even further new message may include a “instruct to sense” indication. The instruct to sense indication received (step 520) by the UE 110, may specify details of the sensing signal that is to be used by the UE 110 when carrying out (step 522) a sensing operation. The details of the sensing signal may include an indication of a particular sensing type along with indications of various sensing signal parameters, including sensing signal bandwidth, sensing signal duration, etc.

The transmission (step 518) of the instruct to sense indication specifying details of the sensing signal may be accomplished using a logical channel, such as the known dedicated traffic channel (DTCH). Alternatively, the BS 170 may use the newly defined logical channel (DSCH), discussed hereinbefore, to transmit (step 518) of the instruct to sense indication to the UE 110.

The details of the sensing signal may include an indication of a UE-specific sensing timing allocation, an indication of a sensing period and an indication of a channel resource that the UE 110 is to use when transmitting (step 524) sensing results to the BS 170. The details of the sensing signal may be communicated to the UE 110 through sensing configuration signaling that is sent to the UE 110 along with the request to_sense indication (step 510). The sensing configuration signaling may be sent through RRC signaling.

The transmission (step 524) of the sensing results may be accomplished using a known physical channel, such as the PUSCH. Alternatively, the transmission (step 524) of the sensing results may be accomplished using the newly defined physical channel, PSCH. The transmission (step 524) of the sensing results may be accomplished using a logical channel, such as the known DTCH. Alternatively, the UE 110 may use the newly defined logical channel (DSCH), discussed hereinbefore, to transmit (step 524) of the sensing results to the BS 170.

The details of the sensing signal may include a “tight synchronization request” (TSR) for the UE 110 in case of bi-static sensing. An explanation of bi-static sensing will be provided hereinafter. Rather than transmitting a TSR as part of the optional transmitting (step 518) of the instruct to sense indication, the TSR may be transmitted separately and subsequent to the transmission of the instruct to sense indication. The TSR may be transmitted, to the UE 110, in conjunction with transmission (step 510) of the request to_sense indication. The UE 110 uses the UE-specific sensing timing allocation and the specified sensing period when carrying out (step 522) the sensing operation. The UE 110 uses the specified channel resource when transmitting (step 524) sensing results to the BS 170. The sensing results may include reference information (for example, for non-camera-based sensing) such as an object identifier, e.g., a tag identifier. The object identifier may have an implicit association with an indication of a particular BS 170. The sensing results may also include further information, e.g., an image, which may be a map.

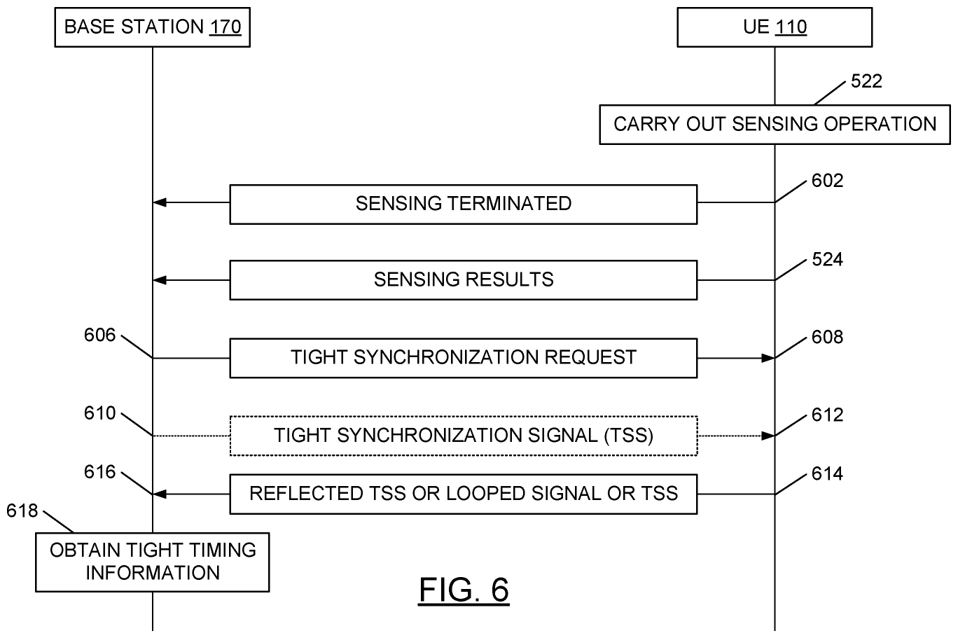

FIG. 6 illustrates, in a signal flow diagram, further possible interaction between the UE 110 and the BS 170 related to the arrangement of sensing assisted by the UE 110. Occasionally, there may be circumstances that trigger the UE 110 to transmit (step 602) a still further new message to the BS 170. The still further new message may include a sensing_terminated indication.

The trigger may take the form of the arrival of traffic for which an urgent UL or SL response is due. Under such circumstances, the UE 110 exits immediately from carrying out (step 522) the sensing operation and transmits (step 602) the sensing_terminated indication to the BS 170.

The UE 110 may then transmit (step 524) sensing results to the BS 170 in the same manner that the UE 110 would have transmitted (step 524) sensing results to the BS 170 in the absence of the trigger that caused sensing to be terminated. It may be possible that the UE 110 cannot transmit (step 524) the sensing results over the specified resources, for example, due to the resources being occupied by traffic. In such a case, the UE 110 may request, from the BS 170, additional resources or indicate, to the BS 170, that the sensing results may not be transmitted over the specified resources.

Several sensing configurations are contemplated. In a “Dynamic” sensing configuration, the sensing operation (step 522, FIG. 5) to be carried out by the UE 110 is scheduled by the BS 170. In this case, the transmission (step 506) of the sensing configuration may be linked with the transmission (step 510) the indication request to_sense.

In a “Semi-Static” sensing configuration, the sensing operation (step 522, FIG. 5) to be carried out by the UE 110 is pre-configured. It follows that “Semi-Static” sensing may also be referred to as “pre-configured sensing.” In pre-configured sensing, detailed sensing configurations are specified by the BS 170 and communicated, by the BS 170, to the UE 110. Accordingly, the BS 170 transmits (step 506) the sensing configuration and the BS 170 does not transmit (step 510) the indication request to_sense. That is, the UE 110 carries out (step 522), on the basis of the configuration, without being prompted, through receipt (step 512) of the request to_sense indication, to begin the sensing operation.

In an “Opportunistic” sensing configuration, the sensing operation (step 522, FIG. 5) is carried out by the UE 110 without any grant from the BS 170. That is, the BS 170 does not transmit (step 510) the indication request to_sense. In contrast to a semi-static sensing configuration (a.k.a., a pre-configured sensing configuration), wherein the BS 170 specifies all detailed configurations, including the transmission resources, in the opportunistic sensing configuration, detailed configurations may not be signaled to the UE 110 beforehand. Indeed, the UE 110 may use configurations previously stored in the UE memory 208. In one example, the UE 110 may carry out (step 522, FIG. 5) the sensing operation by transmitting a sensing signal over some resources about which the BS 170 has no knowledge or expectation.

According to an aspect of the present application, which may be referred to as network-initiated, UE-assisted, mono-static sensing, the sensing (active and passive) is completely outsourced by the BS 170 to the UE 110. The UE 110 performs mono-static sensing (both active and passive). In this case, after receiving (step 504) the sensing capability report from multiple UEs 110, the BS 170 configures a particular UE 110 for mono-static sensing based on the capability and the availability of the particular UE 110. The BS 170 transmits (step 510) a request to sense indication to the particular UE 110.

Responsive to receiving (step 512) the request to_sense indication, the particular UE 110 carries out (step 522) active and passive sensing based on configuration details in a configuration message that the particular UE 110 has previously received (step 508).

After the particular UE 110 has carried out (step 522) the sensing, the particular UE 110 transmits (step 524) the sensing results. Note that, in this example embodiment of an aspect of the present application, there is no need for a tight synchronization request (discussed hereinafter), since the sensing is mono-static. In addition, there might be more than one UE 110 configured, by the BS 170, for carrying out (step 522) mono-static sensing.

According to another aspect of the present application, which may be referred to as network-initiated, UE-assisted, active bi-static sensing, active sensing is carried out by the UE 110 and passive sensing is carried out by the BS 170. This aspect may be found to be of particular use when the UE 110 has a clear view of a target (e.g., the building 430) and is in close range to the target. As passive sensing is performed by the BS 170, no sensing results are expected from the UE 110.

After receiving (step 504) a sensing capability report from multiple UEs 110, report, the BS 170 may transmit (step 506) a sensing configuration indication to a particular UE 110 (or to a group of UEs 110) for active bi-static sensing based on the capability and availability indicated in the received (step 504) sensing capability report. The BS 170 may then transmit (step 510), to the UE(s) 110, a request for sensing assistance with a request to_sense indication. Upon receiving (step 512) the request for sensing assistance, the UE 110 carries out (step 522) active sensing. Since time and frequency synchronization is important to bi-static sensing, the BS 170 may transmit (step 606, FIG. 6), to the UE 110, a tight synchronization request (TSR). In response to receiving (step 608) the TSR, the UE 110 may make efforts to tightly synchronize with the BS 170.

The transmission (step 606) of the TSR may be accomplished using a known channel, such as PMCH, PUCCH, PUSCH or PRACH. Alternatively, the transmission (step 606) of the TSR may be accomplished using the newly defined channel, PSCH.

In some embodiments, the BS 170 does not transmit (step 606), to the UE 110, explicit signaling for a TSR. In these embodiments, it may be considered to be implicit, in the request to_sense indication transmitted in step 510, that configuration for bi-static sensing leads the UE 110 to make efforts to tightly synchronize with the BS 170.

In some embodiments, responsive to receiving (step 608) the TSR, the UE 110 activates a passive reflection mode. Subsequently, the BS 170 transmits (step 610) a tight synchronization signal (TSS). The transmission (step 610) of the TSS may be accomplished using a known channel, such as PMCH, PUCCH, PUSCH or PRACH. Alternatively, the transmission (step 610) of the TSS may be accomplished using the newly defined channel, PSCH. On the basis of having activated the passive reflection mode, the UE 110 passively reflects (step 614) the TSS. Upon receiving (step 616) the reflected TSS, the BS 170 processes the received reflected TSS to, thereby, obtain (step 618) tight timing information. In aspects of the present application, the TSS comprises a relatively high bandwidth signal, thereby enabling relatively high resolution timing recovery. The details of the TSS may be included in the sensing configuration information transmitted in step 506.

In some other embodiments, responsive to receiving (step 608) the TSR, the UE 110 activates a signal looping mode. The UE 110 performs signal looping on the TSS received (step 612) from the BS 170 to, thereby, obtain a looped signal that includes a parameter that can be uniquely associated with the UE 110. The UE 110 transmits (step 614) the looped signal to the BS 170. Upon receiving (step 616) the looped signal, the BS 170 processes the looped signal to, thereby, obtain (step 618) tight timing information and associate the timing information with the specific UE 110 associated with the parameter that is uniquely associated with the UE 110.

In some other embodiments, responsive to receiving (step 608) the TSR, the UE 110 transmits (step 614) a TSS to the BS 170. Upon receiving (step 616) the TSS, the BS 170 processes the received TSS to, thereby, obtain (step 618) tight timing information.

In some embodiments, the UE 110 may transmit (step 614) the TSS while also transmitting an active sensing signal as part of carrying out (step 522) the sensing operation. This embodiment may be especially useful for use with UEs 110 having multiple panels.

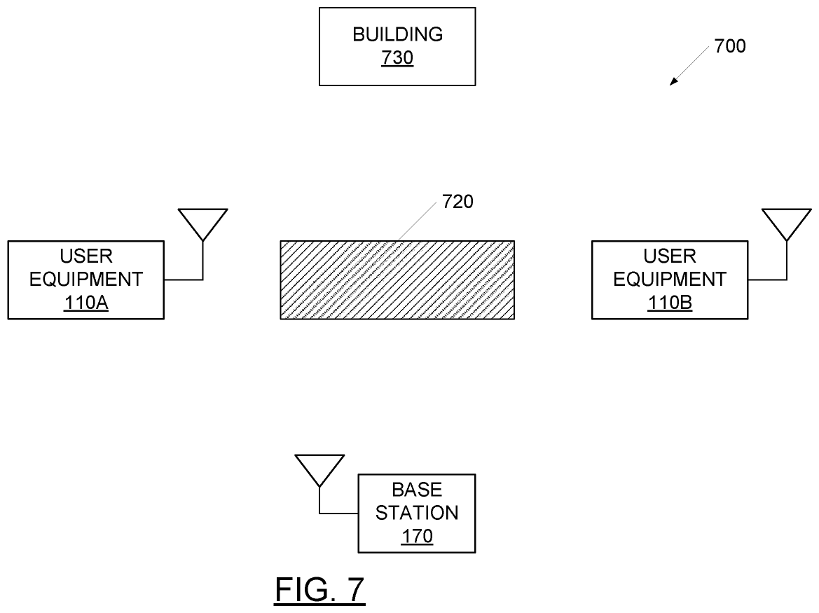

As shown in FIG. 7, an environment 700 includes a BS 170, a first UE 110A, a second UE 110B, a wall 720 and a building 730.

According to a further aspect of the present application, which may be referred to as network-initiated, active and passive bi-static UE sensing, active sensing is carried out by the first UE 110A and passive sensing is carried out by the second UE 110B and the BS 170.

This aspect may be found to be of particular use when the first UE 110A and the second UE 110B have respective clear views of a target (e.g., the building 730) and are in close range to the target. As passive sensing is performed by the BS 170, no sensing results are expected from either UE 110.

After receiving (step 504) the sensing capability report from the UEs 110A, 110B, the BS 170 configures (step 506) the first UE 110A (or a group of UEs 110 that includes the first UE 110A) for active sensing and the BS 170 configures (step 506) the second UE 110B (or a group of UEs 110 including the second UE 110B) for passive sensing. The configuring of the UEs 110A, 110B may be based on the capability and the availability reported by the UEs 110A, 110B. The BS 170 transmits (step 510) a request to_sense indication to the UEs 110A, 110B. After receiving (step 512) the indication, the first UE 110A, configured for active sensing, carries out (step 522) active sensing operations and the second UE 110B, configured for passive sensing, carries out (step 522) passive sensing operations. Since time/frequency synchronization is valuable in bi-static sensing, the BS 170 may transmit a relative tight synchronization request (RTSR) to the UEs 110A, 110B. Since to the UEs 110A, 110B perform bi-static sensing, only their relative synchronization matters, rather than synchronization with the BS 170.

In some embodiments, followed by receiving the RTSR, the first UE 110A, configured for active sensing, transmits a tight synchronization signal (TSS) and the second UE 110B, configured for passive sensing, activates a passive reflection mode to passively reflect the TSS transmitted by the first UE 110B. Receipt and processing of a passively reflected TSS enables the first UE 110A to obtain tight timing information. In aspects of the present application, as discussed hereinbefore, the TSS comprises a relatively high bandwidth signal, thereby enabling relatively high resolution timing recovery. The details of the TSS may be included in the sensing configuration information transmitted in step 506.

In some other embodiments, followed by receiving the RTSR, the first UE 110A, configured for active sensing, transmits the TSS and the second UE 110B, configured for passive sensing, activates a signal looping mode. The second UE 110B performs signal looping on the TSS received from the first UE 110A to, thereby, obtain a looped signal. The second UE 110B transmits the looped signal to the first UE 110A. Upon receiving the looped signal, the first UE 110A processes the looped signal to, thereby, obtain tight timing information.

In some other embodiments, followed by receiving the RTSR, the first UE 110A, configured for active sensing, transmits (using an SL channel) a TSS to the second UE 110B, configured for passive sensing, to enable the second UE 110B to obtain tight synchronization information. In some embodiments, the first UE 110A transmits the TSS while transmitting the active sensing signal as part of the carrying out (step 522) of the sensing operation. This embodiment may be especially useful for use with UEs 110 having multiple panels.

It has been discussed, hereinbefore, that the transmission (step 510) of the request to_sense indication by the BS 170, in so-called network-initiated aspects of the present application, may employ the PDSCH or the PDCCH (for group-cast or unicast) and may employ the PBCH (for broadcasting).

It is contemplated that, rather than being initiated by the BS 170, UE-assisted sensing may be initiated by another UE 110. The other UE 110 may, for one example, employ the known PMCH to transmit (step 510) the request to_sense indication to the UE 110 that is to carry out the sensing. The other UE 110 may, for another example, employ the known PUCCH to transmit (step 510) the request to sense indication to the UE 110 that is to carry out the sensing. In a further example, the other UE 110 may employ the known PUSCH to transmit (step 510) the request to_sense indication to the UE 110 that is to carry out the sensing. In a still further example, the other UE 110 may employ the known PRACH to transmit (step 510) the request to_sense indication to the UE 110 that is to carry out the sensing. It has been discussed hereinbefore that a new channel (PSCH) may be defined expressly for the purpose of transmitting the request to_sense indication. In an even further example, the other UE 110 may employ the known physical sidelink control channel (PSCCH) to transmit (step 510) the request to_sense indication to the UE 110 that is to carry out the sensing. In an even further example, the other UE 110 may employ the known physical sidelink shared channel (PSSCH) to transmit (step 510) the request to sense indication to the UE 110 that is to carry out the sensing.

After receiving (step 512) the request to_sense indication, the UE 110 that is to carry out the sensing may transmit (step 514) a respond to_sense indication to the other UE 110. Similar to the transmission (step 510) of the request to_sense indication, the transmission (step 514) of the respond to_sense indication may be accomplished using a known channel, such as PMCH, PUCCH, PUSCH, PRACH, PSCCH or PSSCH. Alternatively, the transmission (step 514) of the respond to sense indication may be accomplished using the newly defined channel, PSCH.

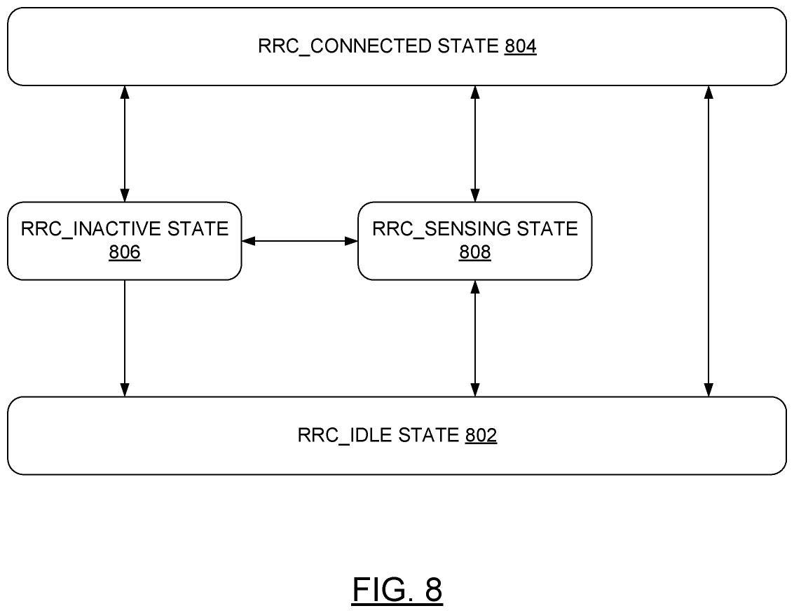

In 3GPP New Radio (NR), a UE 110 may operate in one of the following three RRC states, illustrated in FIG. 8: an RRC_IDLE state 802; an RRC_CONNECTED state 804; and an RRC_INACTIVE state 806. In other documentation, these states may be referenced as “modes”, for example, “RRC_IDLE mode.” When the UE 110 is in the RRC_CONNECTED state 804, the UE 110 may be considered to have been connected to the BS 170 as a result of a connection establishment procedure. When the UE 110 has transitioned to the RRC_IDLE state 802, say, by way of a release procedure, the UE 110 is not connected to the BS 170, but the BS 170 knows that the UE 110 is present in the network. By switching to the RRC_INACTIVE state 806, for example, by way of a release with suspend procedure, the UE 110 helps save network resources and UE power (thereby lengthening, for example, perceived battery life). The RRC_INACTIVE state 806 is known to be useful, for example, in those instances when the UE is not communicating with the BS 170. When the UE is in the RRC_INACTIVE state 806, the BS 170 and the UE both store at least some configuration information to, thereby, allow the UE 110 to reconnect to the BS 170, by way of a resume procedure, more rapidly than the UE 110 would be able to reconnect, by way of the connection establishment procedure, in the case wherein the UE 110 is in the RRC_IDLE state 802. The storage of at least some configuration information when the UE 110 is in the RRC_INACTIVE state 806 is one aspect that distinguishes the RRC_INACTIVE state 806 from the RRC_IDLE state 802.

In an embodiment of the present disclosure, a new RRC state is provided for the UE 110 to occupy when actively sensing. The new RRC state is illustrated in FIG. 8 as an RRC_SENSING state 808. Upon receiving (step 512) the request to_sense indication from the BS 170 and transmitting (step 514) the respond to sense indication acknowledging availability for a sensing operation, the UE 110 may transition from the RRC_CONNECTED state 804 to the RRC_SENSING state 808.

Notably, the RRC_SENSING state 808 is of primary use to the UEs 110 that are configured, upon receiving (step 508) the sensing configuration, for active sensing. Recall that the UEs 110 that are configured for active sensing may not communicate with the BS 170 during the configured sensing period. In particular, the RRC_SENSING state 808 is of primary use to the UEs 110 that are configured for mono-static sensing. In terms of state operation, from a communications standpoint, the RRC_SENSING state 808 may be similar to the RRC_INACTIVE state 806, so that a transition back to the RRC_CONNECTED state 804 may take place very easily and with small latency and power consumption. Once the sensing operation has been carried out (step 522), the UE 110 may transition back to the RRC_CONNECTED state 804 on the basis of RRC resume signaling received from the BS 170.

In an alternative scenario, wherein sensing is initiated by the UE 110, the UE 110 may transition directly from the RRC_IDLE state 802 or the RRC_INACTIVE state 806 to the RRC_SENSING state 808. In this scenario, a new RRC signaling message, perhaps called “RRC sense request,” may be defined. Upon receiving the RRC sense request message from the BS 170, the UE 110 may transition from the RRC_IDLE state 802 or the RRC_INACTIVE state 806 to the RRC_SENSING state 808.

Aspects of the present application related to a user equipment assisting a transmission point by carrying out some environment sensing may be shown to improve sensing coverage and sensing diversity, when compared to environment sensing that is carried out by the transmission point alone. Indeed, the sensing coverage may be increased when the user equipment carries out sensing in an area of the environment that is, otherwise, a blind spot from the perspective of the transmission point. Mobile user equipment may be shown to obtain multiple views of a single target from different angles. Environment sensing that is assisted by user equipment may be shown to provide an opportunity for close-range sensing of specific targets. It should be clear that close-range sensing can be performed with reduced power relative to long-range sensing. Furthermore, close-range sensing may be shown to be less encumbered by interference from various forms of clutter in the environment than long-range sensing.

It should be appreciated that one or more steps of the embodiment methods provided herein may be performed by corresponding units or modules. For example, data may be transmitted by a transmitting unit or a transmitting module. Data may be received by a receiving unit or a receiving module. Data may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the Figures or all of the portions schematically shown in the Figures. Moreover, selected features of one example embodiment may be combined with selected features of other example embodiments.

Although this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

What is claimed is:

1. A method of assisting sensing of an environment, the method comprising:
receiving, by a user equipment (UE), a configuration message, the configuration message indicating details of an environment sensing operation;
receiving, by the UE, reflections of radio frequency signals as part of carrying out the environment sensing operation according to the details indicated in the configuration message; and
transmitting, by the UE, sensing results obtained by processing the received reflections.

2. The method of claim 1, wherein the details of the environment sensing operation include at least one of: a sensing type; a sensing subspace; a target detection performance indicator; a sensing waveform; a sensing signal sequence; a sensing signal time/frequency allocation; an active sensing request; a passive sensing request;
a common sensing indication; a dedicated sensing indication; a feedback channel resource; or a sensing report timeline.

3. The method of claim 1, wherein the carrying out the environment sensing operation comprises an active sensing operation including:
transmitting, by the UE, a first radio frequency signal; and
wherein the receiving the reflections of radio frequency signals comprises
receiving reflections of the first radio frequency signal.

4. The method of claim 1, wherein the carrying out the environment sensing operation comprises a passive sensing operation wherein the receiving the reflections of radio frequency signals includes receiving reflections of radio frequency signals existing in the environment.

5. The method of claim 1, further comprising transmitting, by the UE, an indication of sensing capabilities.

6. The method of claim 1, further comprising transmitting, by the UE, an indication of sensing availability.

7. A device comprising:
a memory storing instructions; and
a processor configured, by executing the instructions, to:
receive a configuration message, the configuration message indicating details of an environment sensing operation;
receive reflections of radio frequency signals as part of carrying out the environment sensing operation according to the details indicated in the configuration message; and
transmit sensing results obtained by processing the received reflections.

8. The device of claim 7, wherein the details of the environment sensing operation include at least one of: a sensing type; a sensing subspace; a target detection performance indicator; a sensing waveform; a sensing signal sequence; a sensing signal time/frequency allocation; an active sensing request; a passive sensing request;
a common sensing indication; a dedicated sensing indication; a feedback channel resource; or a sensing report timeline.

9. The device of claim 7, wherein the carrying out the environment sensing operation comprises an active sensing operation and the processor is further configured, by executing the instructions, to transmit a first radio frequency signal and wherein the receiving the reflections of radio frequency signals comprises receiving reflections of the first radio frequency signal.

10. The device of claim 7, wherein the carrying out the environment sensing operation comprises a passive sensing operation wherein the receiving the reflections of radio frequency signals includes receiving reflections of radio frequency signals existing in the environment.

11. The device of claim 7, wherein the processor is further configured, by executing the instructions, to transmit an indication of sensing capabilities.

12. The device of claim 7, wherein the processor is further configured, by executing the instructions, to transmit an indication of sensing availability.

13. A method of controlling sensing of an environment, the method comprising:
transmitting, by a requesting device, a configuration message, the configuration message indicating details of an environment sensing operation, the environment sensing operation including receiving reflections of radio frequency signals according to the details indicated in the configuration message; and
receiving, by the requesting device, sensing results obtained by processing the received reflections.

14. The method of claim 13, further comprising receiving, by the requesting device, an indication of sensing capabilities.

15. The method of claim 13, further comprising receiving, by the requesting device, an indication of sensing availability.

16. The method of claim 13, wherein the configuration message further indicates resources to use when transmitting the sensing results and the method further comprises employing the resources when receiving the sensing results.

17. The method of claim 13, wherein the configuration message further indicates a sensing type.

18. The method of claim 17, wherein the sensing type comprises one of a radio frequency sensing type, a LIDAR sensing type, or a camera-based sensing type.

19. The method of claim 13, wherein the configuration message further indicates at least one of a sensing timing allocation, a sensing period, or a sensing report timeline.

20. The method of claim 13, further comprising transmitting a request message indicating a request for sensing assistance and receiving a response message responding to the request for sensing assistance.

21. The method of claim 13, further comprising transmitting a message indicating an instruction to carry out the sensing operation, wherein the message indicating the instruction further comprises an indication of at least one of a sensing type, a sensing signal bandwidth, a sensing signal duration, a sensing timing allocation, a sensing period, or a sensing report timeline.
